(19) United States
(12) Patent Application Publication
(10) Pub. No.: US 2014/0351543 A1
(43) Pub. Date: Nov. 27, 2014

(54) Method for Restricting Access to Data Stored on a Memory Card and a Memory Card

(71) Applicant: Wayne Joon Yong Tan, Singapore (SG)

(72) Inventor: Wayne Joon Yong Tan, Singapore (SG)

(73) Assignee: T-DATA SYSTEMS (S) PTE LTD, Singapore (SG)

(21) Appl. No.: 14/344,719

(22) PCT Filed: Sep. 13, 2011
(86) PCT No.: PCT/SG2011/000311

§ 371 Date: Mar. 13, 2014

(51) Int. Cl. G06F 12/14; G06F 12/02

(52) U.S. Cl. CPC G06F 12/1416; G06F 12/0246; G06F 2212/1052; G06F 2212/72
USPC 711/163

(57) ABSTRACT

There is provided a method for restricting access to data stored on a memory card, whereby the restriction of access relates to what is able to be carried out to the data stored on the memory card during wireless communications with the memory card. Furthermore, there is also provided a memory card which is able to restrict access to data stored on it during wireless communications with it.

### FIELD OF INVENTION

The invention relates to restricting access to data stored on a memory card.

### BACKGROUND

Memory cards are currently a common storage medium for digital data on digital cameras. There are some forms of memory cards which have wireless communications capabilities. These memory cards allow both wireless reception and transmission of digital data.

In some of these memory cards, access to data stored on the memory card requires input of a password. When a correct password is input to the memory card using, for example, an input interface on a device which is wirelessly connected to the memory card, access to data stored on the memory card is allowed.

Thus, access to data stored on the memory card is available to any party as long as the correct password is input to the memory card. An identity of the party is not taken into consideration and there are no restrictions in relation to what can be done to the accessed data once the correct password is input. This may be undesirable in many circumstances, such as, for example, when an access password is stolen, when there is private/confidential data stored on the memory card, and so forth.

### SUMMARY

In a first aspect, there is provided a method for restricting access to data stored on a memory card configured to be used in a digital camera having an inbuilt processor incapable of independently exporting digital data externally of the digital camera or independently importing digital data from externally of the digital camera. The method includes selecting a predetermined mode of the digital camera, the predetermined mode being enabled by a tagging software uploaded from the memory card; and associating a tag with digital data using the tagging software, the tag being for restricting access to data stored on the memory card.

The method may further include determining an identity of a device communicating with the memory card; reading the tag associated with digital data stored on the memory card; and setting access rights for the device in accordance with the tag associated with the digital data. Moreover, the method may also include determining if the digital camera is running the tagging software; and uploading the tagging software from the memory card to the digital camera if the digital camera is not running the tagging software.

The identity of a device may preferably include, for example, device identity, device user identity, device user's organization and so forth. It is preferable that the access rights may include, for example, reading the digital data, reading and writing on the digital data, and obtaining the digital data.

Reading the tag may preferably include assessing a look-up table in the tag to associate the identity of a device to the access rights. The tag may be associated with for example, a file, a folder, a partitioned portion in the digital data and so forth. It is also preferable that the identity of a device is determined from a password input to the memory card.

In a second aspect, there is provided a memory card capable of restricting access to data stored on the memory card, the memory card being configured to be used in a digital camera having an inbuilt processor incapable of independently exporting digital data externally of the digital camera or independently importing digital data from externally of the digital camera. The memory card includes a wireless transceiver module being operably connected to at least one of: a central processor, and a storage module; the central processor being configured to control at least one of: reception of digital data by the digital camera, transmission of digital data from the digital camera when the digital data is captured by the digital camera, uploading a tagging software to the digital camera for tagging digital data, and reading the tags of the digital data; and the storage module being operably connected to the central processor and for storing the tagging software.

It is preferable that the central processor of the memory card is operable, when the memory card is physically and operably engaged in and with the digital camera, to upload the tagging software to the inbuilt processor for enabling tagging of digital data stored in the storage module, the tagging being carried out when the digital camera is in a predetermined mode enabled by the tagging software. The predetermined mode may include displaying a graphical user interface on the digital camera.

Preferably, the tag includes a look-up table for associating an identity of a device to access rights. The tag may preferably be associated with, for example, a file, a folder, a partitioned portion in the digital data and so forth. The identity of a device may include, for example, device identity, device user identity, device user's organization and the like. It is also preferable that the access rights include, for example, reading the digital data, reading and writing on the digital data, obtaining the digital data and so forth. The identity of a device may be determined from a password input to the memory card.

The central processor may be configured to upload the tagging software when the central processor does not detect the tagging software in the digital camera.

In a final aspect, there is provided a system for restricting access to data stored on a memory card, the system including the memory card as described in the preceding paragraphs and a digital camera having an inbuilt processor incapable of independently exporting digital data externally of the digital camera or independently importing digital data from externally of the digital camera.

### DESCRIPTION OF FIGURES

In order to ensure that the invention may be fully understood and readily put into practical effect, there is provided, by way of non-limitative example-only exemplary embodiments, the following illustrative figures which are referenced by the subsequent description:

FIG. 1 shows a process flow of a preferred embodiment of a method of the present invention.

FIG. 2 shows a schematic diagram of a memory card of the present invention when in use.

FIG. 3 shows a first example of a look-up table of the present invention.

FIG. 4 shows a graphical user interface of the present invention.

FIG. 5 shows a second example of a look-up table of the present invention.

### DESCRIPTION OF PREFERRED EMBODIMENTS

There is provided a method for restricting access to data stored on a memory card, whereby the restriction of access relates to what is able to be carried out to the data stored on the memory card during wireless communications with the memory card. Furthermore, there is also provided a memory card which is able to restrict access to data stored on it during wireless communications with it.

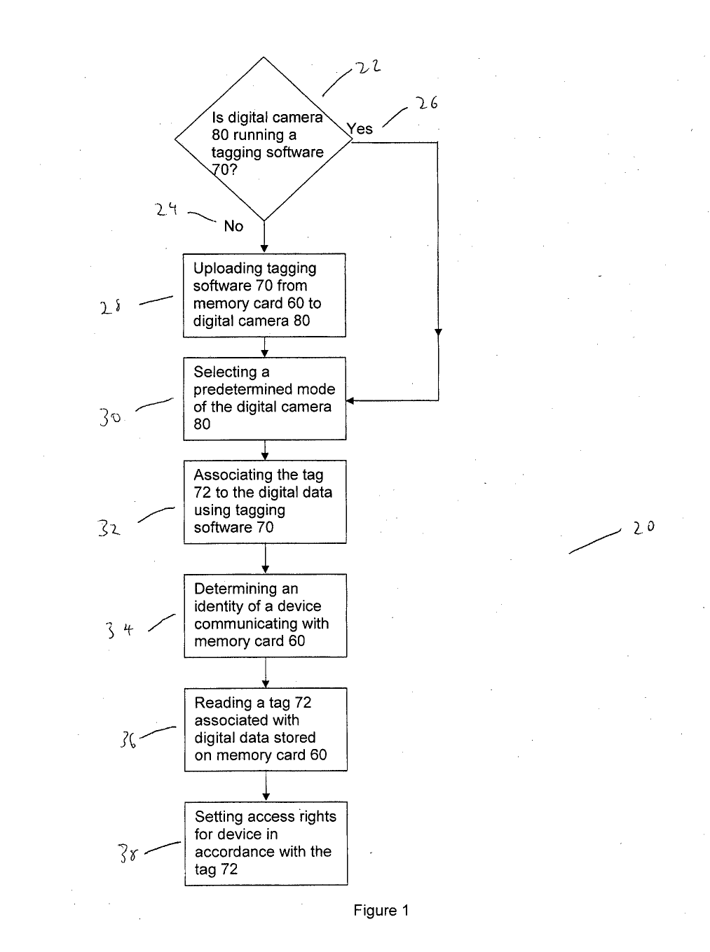

The description in the subsequent paragraphs will refer to labels used in FIGS. 1 to 5 of the specification to aid in enhancing clarity of the description.

Referring to FIG. 1, there is shown a process flow chart depicting a method 20 for restricting access to data stored on a memory card 60. The memory card 60 is configured to be used in a digital camera 80 having an inbuilt processor 82 incapable of independently exporting digital data externally of the digital camera 80 or independently importing digital data from externally of the digital camera 80. In the method 20, the memory card 60 is operably connected to the digital camera 80.

The method 20 includes determining if the inbuilt processor 82 of the digital camera 80 is running tagging software 70 (22). If the inbuilt processor 82 is not running the tagging software 70 (24), the tagging software 70 is uploaded from the memory card 60 to the digital camera 80 (28). The tagging software 70 resides in a RAM 88 of the digital camera 80, and runs on the inbuilt processor 82. Subsequently, a predetermined mode of the digital camera 80 is selected (30). The predetermined mode is known as an “image tagging” mode when the tagging software 70 is running on the inbuilt processor 82. Specifically, the predetermined mode relates to an instance when the tagging software 70 running on the inbuilt processor 82 is activated to associate a tag with a file, a folder or a portion in the digital data. This may be in a manner when a display 86 of the digital camera 80 may show a graphical user interface 120 as depicted in FIG. 4. Further details of the graphical user interface 120 will be provided in a later portion of the description.

If the digital camera 80 is already running the tagging software 70 (26) at step (22), then the predetermined mode of the digital camera 80 is selected (30). There is subsequently an associating of a tag 72 to the digital data stored on the memory card 60 using the tagging software 70 (32). The tag 72 is associated with a file, a folder or a portion in the digital data. As such, there may be multiple tags 72 associated with the digital data. The associating of a tag 72 using the tagging software 70 includes use of the graphical user interface 120 of FIG. 4. The display 86 of the digital camera 80 may be a touch-sensitive panel such that a first option of “read-only” 122, a second option of “read/write” 124 and a third option of “data able to be copied” 126 are able to be selected by physically contacting portions of the display corresponding to the options 122, 124, 126. When “read-only” 122 is selected, data is able to be read but not stored permanently on a separate device communicatively connected to the memory card 60. When “read/write” 124 is selected, data is able to be read and edited but not stored permanently on a separate device communicatively connected to the memory card 60. When “able to be copied” 126 is selected, data is able to be copied and stored permanently on a separate device communicatively connected to the memory card 60. Option 122, and 124 may each be selected concurrently with option 126. It may be necessary for software to be installed on the separate device to enable the options 122, 124, 126 on the separate device.

Alternatively, when the display 86 of the digital camera 80 is not a touch-sensitive panel, the options 122, 124, 126 may be selected using, for example, a cursor controller of the digital camera 80 (allows scrolling through the options 122, 124, 126), a plurality of fixed buttons of the digital camera 80 (each button being respectively associated with the options 122, 124, 126), and so forth.

The separate device with wireless communications capability is able to communicate with the memory card 60 to access data stored on the memory card 60. The device may be, for example, a mobile phone, a portable computer, a tablet computer and the like.

The method 20 also includes determining an identity of the device communicating with the memory card 60 (34), whereby the device is communicating with the memory card in a wireless manner, using, for example, Bluetooth, Wi-fi, UWB, and so forth. The identity of a device may be, for example, device identity, device user identity, device user's organization and so forth. The identity of the device may also be any combination of the aforementioned. The identity of a device may be either obtained from the device itself or input using the device.

The identity of a device may be determined from a password input to the memory card 60 from the device. When the password is input to the memory card 60 either using an input interface of the device or when transmitted from the device as part of a hand-shake procedure, the password may allow a first layer of access to the digital data stored on the memory card 60 (for example, the device is only able to view thumbnail versions of images stored as digital data on the memory card 60), although complete access to the digital data is not allowed.

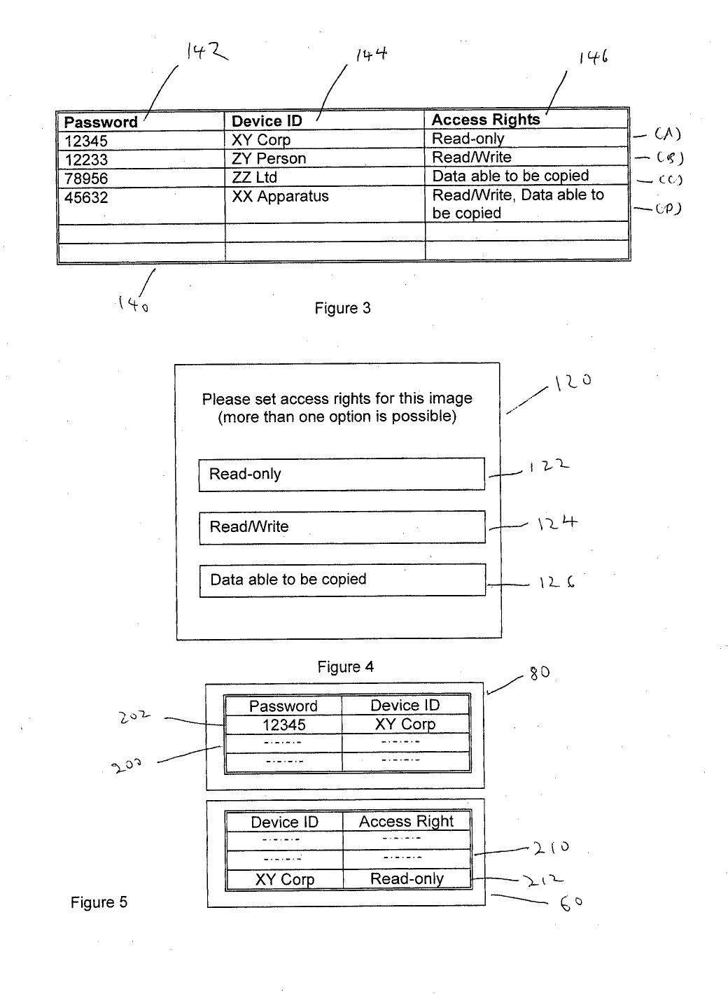

The method 20 subsequently includes reading the tag 72 associated with digital data stored on the memory card 60 (36). Reading the tag 72 includes assessing a look-up table 140 in the tag 72 (as, shown in FIG. 3) to associate the identity of a device to access rights for the device.

It should be appreciated that contents of the look-up table 140 may be input at any time (for example, when new devices are connectable to the memory card 60) when the memory card 60 is connected to another device which is able to write content to the look-up table 140. It should be appreciated that the contents of the look-up table 140 is only able to be input by an entity with either a highest level of access rights, such as an owner of a memory card or is an authenticated entity using known authentication methods.

The look-up table 140 as shown in FIG. 3 includes a password column 142, a device ID column 144 and an access rights column 146. Referring to row (A) of the look-up table 140, when a password “12345” is input by the device, the device is identified as “XY Corp” and has “read-only” access. Likewise, for row (B), when a password “12233” is input by the device, the device is identified as “ZY Person” and has “read/write” access. Other rows (C) and (D) follow an identical convention as rows (A) and (B). It should be appreciated that input of password is optional, and in such an instance, the look-up table 140 does not include the password column 142 and the device inputs a device ID rather than a password. When there is no need for the input of a password, there may not be the first layer of access to the digital data stored on the memory card 60.

It may also be possible that the look-up table 140 as shown in FIG. 3 is divided into separate tables as shown in FIG. 5. For example, the password column 142 and the device ID column 144 form a first table 200 stored in either the RAM 88 of the digital camera 80 or the memory card 60, while the device ID column 144 and the access rights column 146 form a second table 210 stored in the tag 72. A first row 202 of the first table 200 corresponds to a third row 212 of the second table 210 as the device ID is “XY Corp”. When the look-up table 140 is divided into separate tables, an advantage is that a change in password for any device need only be carried out at the first table 200 and not for every tag 72 associated with a file, a folder or a portion in the digital data.

Finally, the method 20 also includes setting access rights for the device in accordance with the tag 72 associated with the digital data (38). The access rights include at least one action selected from, for example, reading the digital data, reading and writing on the digital data, copying the digital data and the like. The access rights may be controlled by a central processor 62 of the memory card 60.

As such, the method 20 allows access to data stored on the memory card 60 to be restricted in accordance with an input from a device wirelessly connected to the memory card 60. For example, when the memory card 60 is used to store image files for an entire family, certain folders may be accessible by all family members while certain folders may be off-limits for some family members. Similarly, even though certain folders may be accessible by all family members, some family members may only be able to view the images in those folders, while other family members may be able to insert captions to the images, and so forth. Thus, the method 20 allows flexibility in relation to how the memory card 60 is used and enables a greater extent of control in relation to how digital data is shared when using the memory card 60.

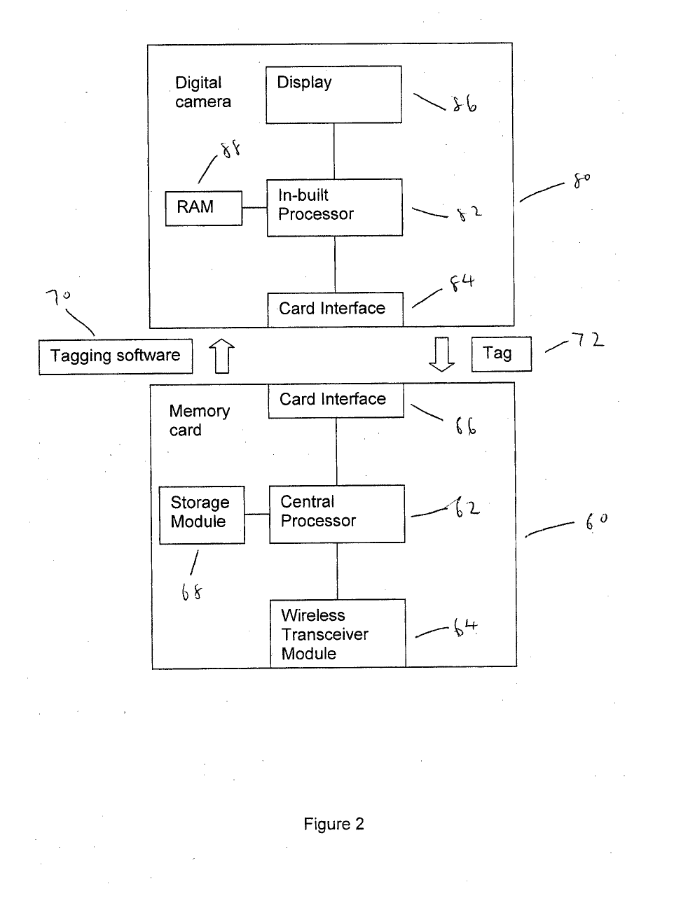

Referring to FIG. 2, there is shown a memory card 60 capable of restricting access to data stored on the memory card 60. The memory card 60 is configured to be used in a digital camera 80 having an inbuilt processor 82 incapable of independently exporting digital data externally of the digital camera 82 or independently importing digital data from externally of the digital camera 82.

The memory card 60 includes a wireless transceiver module 64 being operably connected to at least one of a central processor 62, and a storage module 68. The wireless transceiver module 64 is configured to receive digital data transmitted to the digital camera 80 and to export digital data from the storage module 68. Furthermore, the central processor 62 is also configured to control at least one of the reception of digital data by the digital camera 80, the transmission of digital data from the digital camera 80 when the digital data is captured by the digital camera 80, uploading tagging software 70 to the digital camera 80 for tagging digital data, and reading the tags 72 of the digital data. The central processor 62 uploads the tagging software 70 when the central processor 62 does not detect the tagging software 72 in the digital camera 80. This may be carried out using any known software detection procedure. The storage module 68 is operably connected to the central processor 62 and is also for storing the tagging software 70.

The tag 72 is associated with a file, a folder or a portion in the digital data. As such, there may be multiple tags 72 associated with the digital data. The associating of a tag 72 using the tagging software 70 includes use of the graphical user interface 120 of FIG. 4. The display 86 of the digital camera 80 may be a touch-sensitive panel such that a first option of “read-only” 122, a second option of “read/write” 124 and a third option of “data able to be copied” 126 is able to be selected by physically contacting portions of the display corresponding to the options 122, 124, 126. When “read-only” 122 is selected, data is able to be read but not stored permanently on a separate device communicatively connected to the memory card 60. When “read/write” 124 is selected, data is able to be read and edited but not stored permanently on a separate device communicatively connected to the memory card 60. When “able to be copied” 126 is selected, data is able to be copied and stored permanently on a separate device communicatively connected to the memory card 60. Option 122, and 124 may each be selected concurrently with option 126. It may be necessary for software to be installed on the separate device to enable the options 122, 124, 126 on the separate device.

Alternatively, when the display 86 of the digital camera 80 is not a touch-sensitive panel, the options 122, 124, 126 may be selected using, for example, a cursor controller of the digital camera 80 (allows scrolling through the options 122, 124, 126), a plurality of fixed buttons of the digital camera 80 (each button being respectively associated with the options 122, 124, 126), and so forth.

The tag 72 may include a look-up table 140 (as shown in FIG. 3) to associate an identity of a device to access rights for the device. Contents of the look-up table 140 may be input when the memory card 60 is connected to another device which is able to write content to the look-up table 140. It should be appreciated that the contents of the look-up table 140 is only able to be input by an entity with either a highest level of access rights, such as the owner of a memory card or is an authenticated entity using known authentication procedures.

It may also be possible that the look-up table 140 as shown in FIG. 3 is divided into separate tables as shown in FIG. 5. For example, the password column 142 and the device ID column 144 form a first table 200 stored in the RAM 88 of the digital camera 80, while the device ID column 144 and the access rights column 146 form a second table 210 stored in the tag 72. A first row 202 of the first table 200 corresponds to a third row 212 of the second table 210 as the device ID is “XY Corp”. When the look-up table 140 is divided into separate tables, an advantage is that a change in password for any device need only be carried out at the first table 200 and not for every tag 72 associated with a file, a folder or a portion in the digital data.

The separate device with wireless communications capability is able to communicate with the memory card 60 to access data stored on the memory card 60. The device may be, for example, a mobile phone, a portable computer, a tablet computer and the like.

The identity of the device may be, for example, device identity, device user identity, device user's organization and so forth. The identity of the device may also be any combination of the aforementioned. The identity of a device may be either obtained from the device itself or input using the device.

The identity of a device may be determined from a password input to the memory card 60 from the device. When the password is input to the memory card 60 either using an input interface of the device or when transmitted from the device as part of a hand-shake procedure, the password may allow a first layer of access to the digital data stored on the memory card 60 (for example, the device is only able to view thumbnail versions of images stored as digital data on the memory card 60), although complete access to the digital data is not allowed.

Access rights to the digital data include at least one action selected from, for example, reading the digital data, reading and writing on the digital data, obtaining the digital data (includes copying and cutting) and the like. The access rights may be controlled by the central processor 62 of the memory card.

The central processor 62 of the memory card 60 is operable when the memory card 60 is physically and operably engaged in and with the digital camera 80 when card interfaces 66, 84 are coupled together. The central processor 62 is then able to upload the tagging software 70 to the inbuilt processor 82, specifically the RAM 88, for enabling tagging of digital data stored in the storage module 68, the tagging being carried out when the digital camera 80 is in a predetermined mode enabled by the tagging software 70. The predetermined mode may be known as an “image tagging” mode when the tagging software 70 is running on the inbuilt processor 82. Specifically, the predetermined mode relates to an instance when the tagging software 70 running on the inbuilt processor 82 is activated to associate a tag with a file, a folder or a portion in the digital data. This may be in a manner when a display 86 of the digital camera 80 may show a graphical user interface 120 as depicted in FIG. 4.

The memory card 60 is configured to restrict access to data stored on the memory card 60 in accordance with an input from a device wirelessly connected to the memory card 60. For example, when the memory card 60 is used to store image files for an entire family, certain folders may be accessible by all family members while certain folders may be off-limits for some family members. Similarly, even though certain folders may be accessible by all family members, some family members may only be able to view the images in those folders, while other family members may be able to insert captions to the images, and so forth. Thus, the memory card 60 is flexible in relation to usability and also enables a greater extent of control in relation to how digital data is shared.

Whilst the foregoing description has described exemplary embodiments, it will be understood by those skilled in the technology concerned that many variations in details of design, construction and/or operation may be made without departing from the present invention.

1. A method for restricting access to data stored on a memory card configured to be used in a digital camera having an inbuilt processor incapable of independently exporting digital data externally of the digital camera or independently importing digital data from externally of the digital camera, the method including:
selecting a predetermined mode of the digital camera, the predetermined mode being enabled by a tagging software uploaded from the memory card; and
associating a tag with digital data using the tagging software, the tag being for restricting access to data stored on the memory card.

2. The method as claimed in claim 1, further including:
determining an identity of a device communicating with the memory card;
reading the tag associated with digital data stored on the memory card; and
setting access rights for the device in accordance with the tag associated with the digital data.

3. The method as claimed in claim 1, further including:
determining if the digital camera is running the tagging software;
uploading the tagging software from the memory card to the digital camera if the digital camera is not running the tagging software.

4. The method as claimed in claim 1, wherein the identity of a device is at least one selected from a group consisting of: device identity, device user identity, and device user's organization.

5. The method as claimed in claim 1, wherein the access rights is at least one selected from a group consisting of: reading the digital data, reading and writing on the digital data, and obtaining the digital data.

6. The method as claimed in claim 1, wherein reading the tag includes assessing a look-up table in the tag to associate the identity of a device to the access rights.

7. The method as claimed in claim 1, wherein the tag is associated with one from a group consisting of: a file, a folder and a partitioned portion in the digital data.

8. The method as claimed in claim 1, wherein the identity of a device is determined from a password input to the memory card.

9. A memory card capable of restricting access to data stored on the memory card, the memory card being configured to be used in a digital camera having an inbuilt processor incapable of independently exporting digital data externally of the digital camera or independently importing digital data from externally of the digital camera, the memory card including:
a wireless transceiver module being operably connected to at least one of: a central processor, and a storage module;
the central processor being configured to control at least one of: reception of digital data by the digital camera, transmission of digital data from the digital camera when the digital data is captured by the digital camera, uploading a tagging software to the digital camera for tagging digital data, and reading the tags of the digital data; and
the storage module being operably connected to the central processor and for storing the tagging software;
wherein the central processor of the memory card is operable, when the memory card is physically and operably engaged in and with the digital camera, to upload the tagging software to the inbuilt processor for enabling tagging of digital data stored in the storage module, the tagging being carried out when the digital camera is in a predetermined mode enabled by the tagging software.

10. The memory card as claimed in claim 9, wherein the tag includes a lookup table for associating an identity of a device to access rights.

11. The memory card as claimed in claim 10, wherein the identity of a device is at least one selected from a group consisting of: device identity, device user identity, and device user's organization.

12. The memory card as claimed in claim 10, wherein the access rights is at least one selected from a group consisting of: reading the digital data, reading and writing on the digital data, and obtaining the digital data.

13. The memory card as claimed in claim 9, wherein the central processor is configured to upload the tagging software when the central processor does not detect the tagging software in the digital camera.

14. The memory card as claimed in claim 9, wherein the predetermined mode includes displaying a graphical user interface on the digital camera.

15. The memory card as claimed in claim 9, wherein the tag is associated with one from a group consisting of: a file, a folder and a partitioned portion in the digital data.

16. The memory card as claimed in claim 10, wherein the identity of a device is determined from a password input to the memory card.

17. A system for restricting access to data stored on a memory card, the system including the memory card as claimed in claim 9 and a digital camera having an inbuilt processor incapable of independently exporting digital data externally of the digital camera or independently importing digital data from externally of the digital camera.
